(19) United States
(12) Patent Application Publication
(10) Pub. No.: US 2019/0279082 A1
(43) Pub. Date: Sep. 12, 2019

(54) METHODS AND APPARATUS TO DETERMINE WEIGHTS FOR USE WITH CONVOLUTIONAL NEURAL NETWORKS

(71) Applicant: Movidius LTD., Dublin (IE)

(72) Inventors: David Moloney, Dublin (IE); Alireza Dehghani, Dublin (IE); Aubrey Keith Dunne, Newbridge (IE)

(21) Appl. No.: 15/914,854

(22) Filed: Mar. 7, 2018

(51) Int. Cl. G06N 3/08; G06N 3/04

(52) U.S. Cl. CPC G06N 3/08; G06N 3/0454

(57) ABSTRACT

An example includes sending first weight values to first client devices; accessing sets of updated weight values provided by the first client devices, the updated weight values generated by the first client devices training respective first convolutional neural networks (CNNs) based on: the first weight values, and sensor data generated at the client devices; testing performance in a second CNN of at least one of: the sets of the updated weight values, or a combination of ones of the updated weight values from the sets of the updated weight values; selecting server-synchronized weight (SSW) values from the at least one of: the sets of the updated weight values, or a combination of ones of the updated weight values from the sets of the updated weight values; and sending the SSW values to at least one of: at least some of the first client devices, or second client devices.

### FIELD OF THE DISCLOSURE

This disclosure is generally related to mobile computing, and more specifically to methods and apparatus to determine weights for use with convolutional neural networks.

### BACKGROUND

Handheld mobile computing devices such as cellular telephones and handheld media devices, other types of computing devices such as tablet computing devices and laptop computers are often equipped with cameras. Such cameras are operated by users to capture digital images and videos. Computing devices are sometimes also equipped with other types of sensors including microphones to capture digital audio recordings. Digital images and videos and digital audio recordings can be stored locally at a memory of the computing device, or they can be sent to a network-accessible storage location across a public network such as the Internet or across a private network. In any case, the digital images and videos and digital audio may be subsequently accessed by the originators of those images and videos or by other persons having access privileges.

### BRIEF DESCRIPTION OF THE DRAWINGS

FIG. 1A illustrates an example client device in the form of a mobile camera.

FIG. 1B illustrates an example hardware platform capable of executing the machine-readable instructions of FIG. 6 to implement the mobile cameras of FIGS. 1A, 1B, and 2 and/or the VPU of FIGS. 1A and 1B to generate adjusted weights for use with corresponding CNNs.

FIG. 2 illustrates example client devices in the form of mobile phone host devices in wireless communication with corresponding mobile cameras and a cloud system.

FIG. 3 illustrates an example implementation of the mobile cameras of FIGS. 1A, 1B, and 2 that may be used to train corresponding convolutional neural networks (CNNs) and generate updated weight values for use with feature recognition processes of the CNNs to identify features based on sensor data.

FIG. 4 illustrates an example implementation of the server-synchronized weights generator of FIG. 2 that may be implemented in a server of the cloud system of FIG. 2 to generate server-synchronized weights for use in the CNNs of the mobile cameras of FIGS. 1A, 1B, and 2.

FIG. 5 illustrates a flowchart representative of example machine-readable instructions that may be executed to implement the server-synchronized weights generator of FIGS. 2 and 4 to generate server-synchronized weights for use in CNNs of the mobile cameras of FIGS. 1A, 1B, 2, and 3.

FIG. 6 is a flowchart representative of example machine-readable instructions that may be executed to implement the mobile cameras of FIGS. 1A, 1B, 2, and 3 and/or the VPU of FIGS. 1A and 1B to generate updated weights for use with corresponding CNNs.

FIG. 7 is a processor platform capable of executing the machine-readable instructions of FIG. 5 to implement the server-synchronized weights generator of FIGS. 2 and 4 to generate server-synchronized weights for use in CNNs of the mobile cameras of FIGS. 1A, 1B, 2, and 3.

The figures are not to scale. Instead, for purposes of clarity, different illustrated aspects may be enlarged in the drawings. In general, the same reference numbers will be used throughout the drawings and accompanying written description to refer to the same or like parts.

### DETAILED DESCRIPTION

Example methods and apparatus disclosed herein generate and provide convolutional neural network (CNN) weights in a cloud-based system for use with CNNs in client devices. Examples disclosed herein are described in connection with client devices implemented as mobile cameras that can be used for surveillance monitoring, productivity, entertainment, and/or as technologies that assist users in their day-to-day activities (e.g., assistive technologies). Example mobile cameras monitor environmental characteristics to identify features of interest in such environmental characteristics. Example environmental characteristics monitored by such mobile cameras include visual characteristics, audio characteristics, and/or motion characteristics. To monitor such environmental characteristics, example mobile cameras disclosed herein are provided with multiple sensors. Example sensors include cameras, microphones, and/or motion detectors. Other types of sensors to monitor other types of environmental characteristics may also be provided without departing from the scope of this disclosure.

Convolutional neural networks, or CNNs, are used in feature recognition processes to recognize features in different types of data. For example, a structure of a CNN includes a number of neurons (e.g., nodes) that are arranged and/or connected to one another in configurations that are used to filter input data. By using the neurons to apply such filtering as input data propagates through the CNN, the CNN can generate a probability value or probability values indicative of likelihoods that one or more features are present in the input data. For example, a CNN may produce a 1.1% probability that input image data includes a dog, a 2.3% probability that the input image data includes a cat, and a 96.6% probability that the input image includes a person. In this manner, a device or computer can use the probability values to confirm that the feature or features with the highest probability or probabilities is/are present in the input data.

Filtering applied by CNNs is based on CNN network weights. As used herein, CNN network weights are coefficient values that are stored, loaded, or otherwise provided to a CNN for use by neurons of the CNN to perform convolutions on input data to recognize features in the input data. By varying the values of the CNN network weights, the convolutions performed by the CNN on the input data result in different types of filtering. As such, the filtering quality or usefulness of such convolutions to detect desired features in input data is based on the values used for the CNN network weights. For example, a CNN can be trained to detect or recognize features in data by testing different CNN network weight values and adjusting such weight values to increase the accuracies of generated probabilities corresponding to the presence of particular features in the data. When satisfactory weight values are found, the weight values can be loaded in a CNN for use in analyzing subsequent input data. From time to time, a CNN can be re-trained to adjust or refine the CNN network weight values for use in different environmental conditions, for use with different qualities of data, and/or for use to recognize different or additional features. Examples disclosed herein may be used to generate and/or adjust CNN network weights for use in connection with any type of input data to be analyzed by CNNs for feature recognition. Example input data includes sensor data generated by sensors such as cameras (e.g., images or video), microphones (e.g., audio data, acoustic pressure data, etc.), motion sensors (e.g., motion data), temperature sensors (e.g., temperature data), pressure sensors (e.g., atmospheric pressure data), humidity sensors (e.g., humidity data), radars (e.g., radar data), radiation sensors (e.g., radiation data), radio frequency (RF) sensors (e.g., RF data), etc. Other example input data may be computer-generated data and/or computer-collected data. For example, examples disclosed herein may be employed to generate and/or adjust CNN network weights to perform CNN-based feature recognition on large volumes of collected and/or generated data to identify patterns or features in past events, present events, or future events in areas such as sales, Internet traffic, media viewing, weather forecasting, financial market performance analyses, investment analyses, infectious disease trends, and/or any other areas in which features, trends, or events may be detected by analyzing relevant data.

Examples disclosed herein implement crowd-sourced or federated learning by collecting large quantities of device-generated CNN network weights from a plurality of client devices and using the collected CNN network weights in combination to generate improved sets of CNN network weights at a cloud server or other remote computing device that can access the device-generated CNN network weights. For example, the cloud server, or other remote computing device, can leverage client-based learning in a crowd-sourced or federated learning manner by using refined or adjusted CNN network weights (e.g., adjusted weights) that are generated by multiple client devices. That is, as client devices retrain their CNNs to optimize their CNN-based feature recognition capabilities, such retraining results in device-generated adjusted CNN network weights that are improved over time for more accurate feature recognition. In examples disclosed herein, the cloud server collects such device-generated adjusted CNN network weights from the client devices and uses the device-generated adjusted CNN network weights to generate improved CNN network weights that the cloud server can send to the same or different client devices to enhance feature recognition capabilities of those client devices. Such CNN network weights generated at the cloud server, or other remote computing device, are referred to herein as server-synchronized CNN network weights (e.g., server-synchronized weights, server-synchronized weight values).

By sending (e.g., broadcasting, multicasting, etc.) server-synchronized weights to multiple client devices, examples disclosed herein can be used to improve feature recognition process of some client devices by leveraging CNN learning or CNN training performed by other client devices. This can be useful to overcome poor feature recognition capabilities of client devices that have not been properly trained or new client devices that are put into use for the first time and, thus, have not had the opportunities to train as other client devices have had. In addition, training a CNN can require more power than available to a client device at any time or at particular times (e.g., during the day) based on its use model. That is, due to the power requirements, CNN training may be performed only when a client device is plugged into an external power source (e.g., an alternating current (AC) charger). A rechargeable battery-operated client device may only be charged at night or once every few days, in which case CNN training opportunities would be seldom (e.g., when the client device is plugged into a charger). Some client devices may be powered by replaceable non-chargeable batteries, in which case CNN training opportunities may exist only when fully powered fresh batteries are placed in the client devices. Alternatively, CNN training opportunities may not exist for such client devices. In any such case, client devices that have few or no training opportunities can significantly benefit from examples disclosed herein by receiving server-synchronized weights that are based on weights generated by a plurality of other client devices and processed by a cloud server or other remote computing device.

As discussed above, examples disclosed herein are implemented by collecting device-generated weights at a cloud server from a plurality of client devices. By collecting such device-generated weights to generate improved server-synchronized weights, examples disclosed herein substantially decrease or eliminate the need for cloud servers to collect raw sensor data from the client devices to perform server-based CNN training and CNN network weight testing. That is, although a cloud server could perform CNN training to generate CNN network weights based on raw sensor data collected from client devices, examples disclosed herein eliminate such need by instead crowd-sourcing the device-generated weights from the client devices and using such device-generated weights to generate the improved server-synchronized weights. In this manner, client devices need not transmit raw sensor data to the cloud server. By not transmitting such data, examples disclosed herein are useful to protect privacies of people, real property, and/or personal property that could be reflected in the raw sensor data and/or metadata (e.g., images, voices, spoken words, property identities, etc.). Transmitting device-generated weights from the client devices to the cloud server is substantially more secure than transmitting raw sensor data because if the device-generated weights are intercepted or accessed by a third-party, the weights cannot be reverse engineered to reveal personal private information. As such, examples disclosed herein are particularly useful to protect such personal private information from being divulged to unauthorized parties. In this manner, examples disclosed herein may be used to develop client devices that comply with government and/or industry regulations regarding privacy protections of personal information. An example of such a government regulation of which compliance can be facilitated using examples disclosed herein is the European Union (EU) General Data Protection Regulation (GDPR), which is designed to harmonize data privacy laws across Europe, to protect and empower all EU citizens regarding data privacy, and to reshape the way organizations across the EU region approach data privacy.

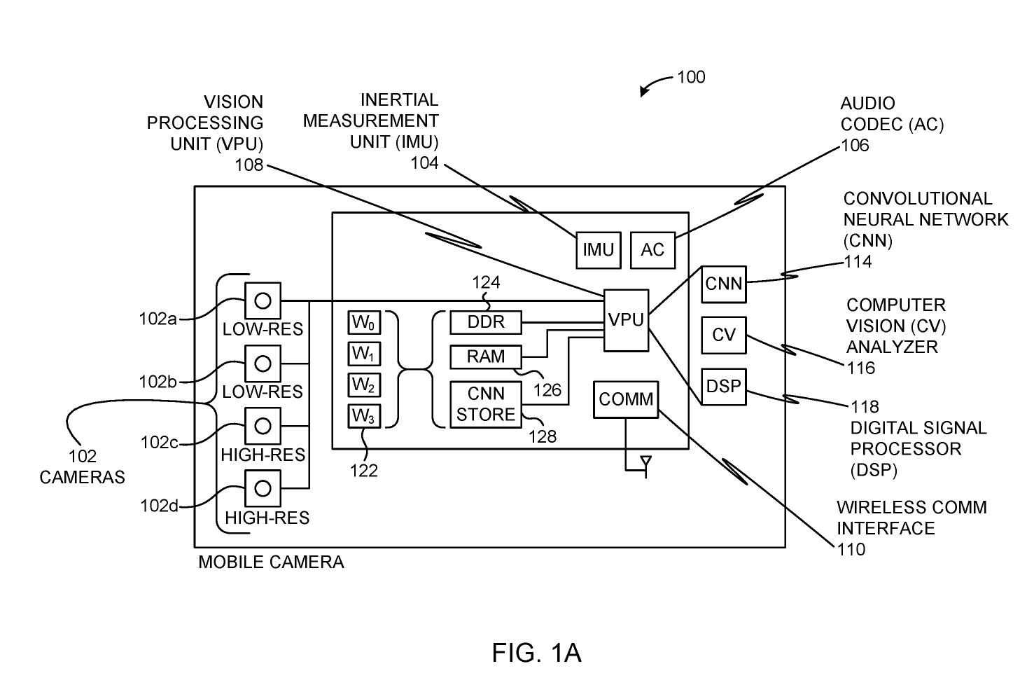

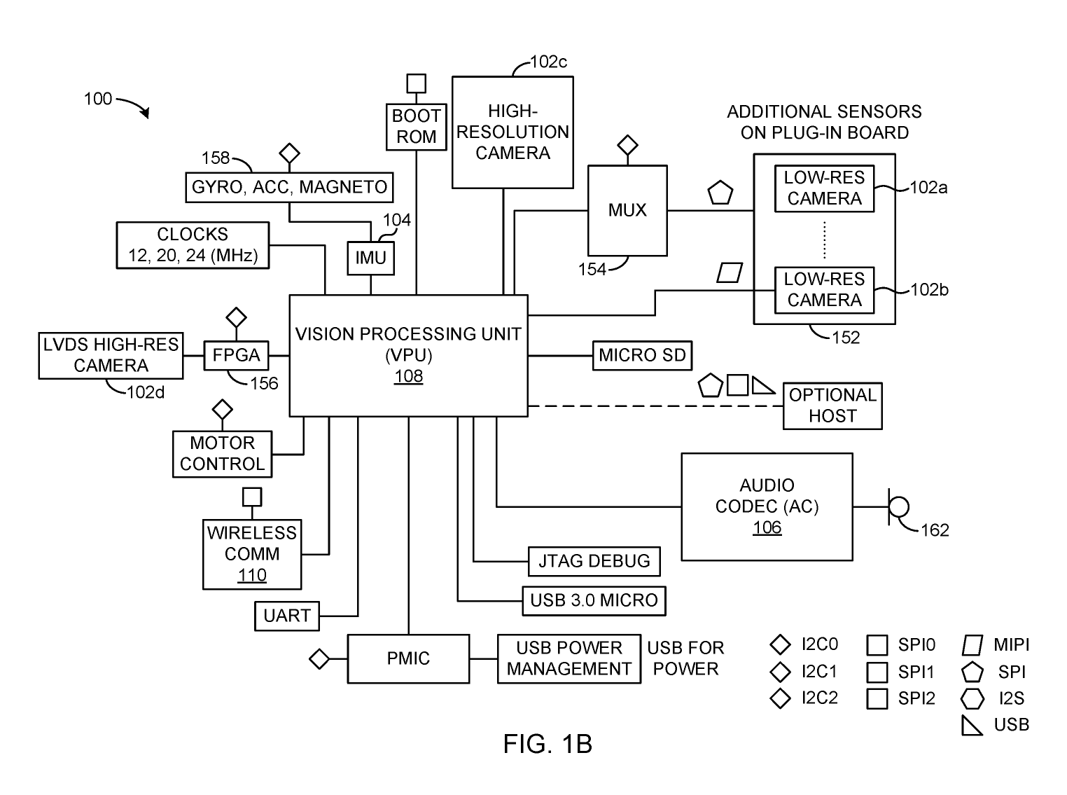

FIG. 1A illustrates an example client device in the form of a mobile camera 100 that includes a plurality of example cameras 102, an example inertial measurement unit (IMU) 104, an example audio codec (AC) 106, an example vision processing unit (VPU) 108, and an example wireless communication interface 110. FIG. 1B is an example hardware platform that may be used to implement the mobile camera 100.

The example mobile camera 100 may be a wearable camera and/or a mountable camera. A wearable camera may be worn or carried by a person. For example, the person may pin or attach the wearable camera to a shirt or lapel, wear the wearable camera as part of eyeglasses, hang the wearable camera from a lanyard around their neck, clip the wearable camera to their belt via a belt clip, clip or attach the wearable camera to a bag (e.g., a purse, a backpack, a briefcase, etc.), and/or wear or carry the wearable camera using any other suitable technique. In some examples, a wearable camera may be clipped or attached to an animal (e.g., a pet, a zoo animal, an animal in the wild, etc.). A mountable camera may be mounted to robots, drones, or stationary objects in any suitable manner to monitor its surroundings.

Example mobile cameras disclosed herein implement eyes on things (EOT) devices that interoperate with an EOT platform with which computers (e.g., servers, client devices, appliances, etc.) across the Internet can communicate via application programming interfaces (APIs) to access visual captures of environments, persons, objects, vehicles, etc. For example, a cloud service (e.g., provided by the cloud system 206) may implement such EOT platform to collect and/or provide access to the visual captures. In some examples, such visual captures may be the result of machine vision processing by the EOT devices and/or the EOT platform to extract, identify, modify, etc. features in the visual captures to make such visual captures more useful for generating information of interest regarding the subjects of the visual captures.

“Visual captures” are defined herein as images and/or video. Visual captures may be captured by one or more camera sensors of the mobile cameras 102. In examples disclosed herein involving the processing of an image, the image may be a single image capture or may be a frame that is part of a sequence of frames of a video capture. The example cameras 102 may be implemented using, for example, one or more CMOS (complementary metal oxide semiconductor) image sensor(s) and/or one or more CCD (charge-coupled device) image sensor(s). In the illustrated example of FIGS. 1A and 1B, the plurality of cameras 102 includes two low-resolution cameras 102a,b and two high-resolution cameras 102c,d. However, in other examples, some or all of the cameras 102 may be low resolution, and/or some or all of the cameras 102 may be high resolution. Alternatively, the cameras 102 may include some other combination of low-resolution cameras and high-resolution cameras.

Turning briefly to the example of FIG. 1B, the low-resolution cameras 102a,b are in circuit with the VPU 108 via a plug-in board 152 which serves as an expansion board through which additional sensors may be connected to the VPU 108. An example multiplexer 154 is in circuit between the VPU 108 and the plug-in board 152 to enable the VPU 108 to select which sensor to power and/or to communicate with on the plug-in board 152. Also in the illustrated example of FIG. 1B, the high-resolution camera 102c is in circuit directly with the VPU 108. The low-resolution cameras 102a,b and the high-resolution camera 102c may be connected to the VPU via any suitable interface such as a Mobile Industry Processor Interface (MIPI) camera interface (e.g., MIPI CSI-2 or MIPI CSI-3 interface standards) defined by the MIPI® Alliance Camera Working Group, a serial peripheral interface (SPI), an I2C serial interface, a universal serial bus (USB) interface, a universal asynchronous receive/transmit (UART) interface, etc. The high-resolution camera 102d of the illustrated example is shown as a low-voltage differential signaling (LVDS) camera that is in circuit with the VPU 108 via a field programmable gate array (FPGA) 156 that operates as an LVDS interface to convert the LVDS signals to signals that can be handled by the VPU 108. In other examples, the VPU 108 may be provided with a LVDS interface and the FPGA may be omitted. In other examples, any combination of the low-resolution cameras 102a,b and the high-resolution cameras 102c,d may be in circuit with the VPU 108 directly, indirectly, and/or via the plug-in board 152. In any case, the mobile camera 100 can completely power off any or all the cameras 102a-d and corresponding interfaces so that the cameras 102a-d and the corresponding interfaces do not consume power.

In some examples, the multiple cameras 102a-d of the illustrated example may be mechanically arranged to produce visual captures of different overlapping or non-overlapping fields of view. Visual captures of the different fields of view can be aggregated to form a panoramic view of an environment or form an otherwise more expansive view of the environment than covered by any single one of the visual captures from a single camera. In some examples, the multiple cameras 102a-d may be used to produce stereoscopic views based on combining visual captures captured concurrently via two cameras. In some examples, as in FIGS. 1A and 1B, a separate high-resolution camera may be provided for each low-resolution camera. In other examples, a single low-resolution camera is provided for use during a low-power feature monitoring mode, and multiple high-resolution cameras are provided to generate high-quality multi-view visual captures and/or high-quality stereoscopic visual captures when feature of interest confirmations are made using the low-resolution camera. In some examples in which the mobile camera 100 is mounted on non-human carriers such as unmanned aerial vehicles (UAVs), robots, or drones, the mobile camera 100 may be provided with multiple cameras mounted around a 360-degree arrangement and top and bottom placements so that the multiple cameras can provide a complete view of an environment. For example, if the mobile camera 100 is mounted on a drone, it may have six cameras mounted at a front position, a back position, a left position, a right position, a top position, and a bottom position. In some examples, a single or multiple low-resolution and/or low-power cameras can be connected to the mobile camera 100 through a length of cable for use in applications that require inserting, feeding, or telescoping a camera through an aperture or passageway that is inaccessible by the mobile camera 100 in its entirety. Such an example application is a medical application in which a doctor needs to feed cameras into the body of a patient for further investigation, diagnosis, and/or surgery.

The example IMU 104 of FIGS. 1A and 1B is an electronic device that measures and reports movements in three-dimensional (3D) space associated with a carrier (e.g., a person, an object, a vehicle, a drone, a UAV, etc.) of the mobile camera 100 such as force, angular rate, and/or surrounding magnetic field. To measure such movements, the example IMU 104 may be in circuit with one or more motion sensors 158 (FIG. 1B) such as one or more accelerometers, one or more gyroscopes, one or more magnetometers, etc. The example AC 106 can be used to detect ambient sounds including speech generated by a person carrying the mobile camera 100 and/or generated by persons in proximity to the mobile camera 100. To detect such sounds, the AC 106 may be in circuit with one or more microphones 162 (FIG. 1B). In other examples, other sensor interfaces may be provided to monitor for other environmental characteristics. For example, the mobile camera 100 may additionally or alternatively be provided with a temperature sensor interface, a pressure sensor interface, a humidity sensor interface, a radiation sensor interface, etc.

The example VPU 108 is provided to perform computer vision processing to provide visual awareness of surrounding environments. The example VPU 108 also includes capabilities to perform motion processing and/or audio processing to provide motion awareness and/or audio awareness. For example, the VPU 108 may interface with multiple sensors or sensor interfaces, including the cameras 102, the IMU 104, the motion sensors 158, the AC 106, and/or the microphone 162 to receive multiple sensor input data. As shown in FIG. 1A, the example VPU 108 is provided with one or more convolutional neural networks (CNNs) 114, one or more computer vision (CV) analyzers 116, and/or one or more audio digital signal processors (DSPs) 118 to process such sensor input data. In this manner, the example VPU 108 can perform visual processing, motion processing, audio processing, etc. on the sensor input data from the various sensors to provide visual awareness, motion awareness, and/or audio awareness. The VPU 108 of the illustrated example may be implemented using a VPU from the Myriad™ X family of VPUs and/or the Myriad™ 2 family of VPUs designed and sold by Movidius™,a company of Intel Corporation. Alternatively, the example VPU 108 may be implemented using any other suitable VPU.

In the illustrated example, the VPU 108 processes pixel data from the cameras 102, motion data from the IMU 104, and/or audio data from the AC 106 to recognize features in the sensor data and to generate metadata (e.g., this is a dog, this is a cat, this is a person, etc.) describing such features. In examples disclosed herein, the VPU 108 may be used to recognize and access information about humans and/or non-human objects represented in sensor data. In examples involving accessing information about humans, the VPU 108 may recognize features in the sensor data and generate corresponding metadata such as a gender of a person, age of a person, national origin of a person, name of a person, physical characteristics of a person (e.g., height, weight, age, etc.), a type of movement (e.g., walking, running, jumping, sitting, sleeping, etc.), vocal expressions (e.g., happy, excited, angry, sad, etc.), etc. In an example involving accessing information about non-human objects, the mobile cameras 204 may be used by patrons in an art museum to recognize different pieces of art, retrieve information (e.g., artwork name, artist name, creation date, creation place, etc.) about such art from a cloud service and access the retrieved information via the mobile phone host devices 202.

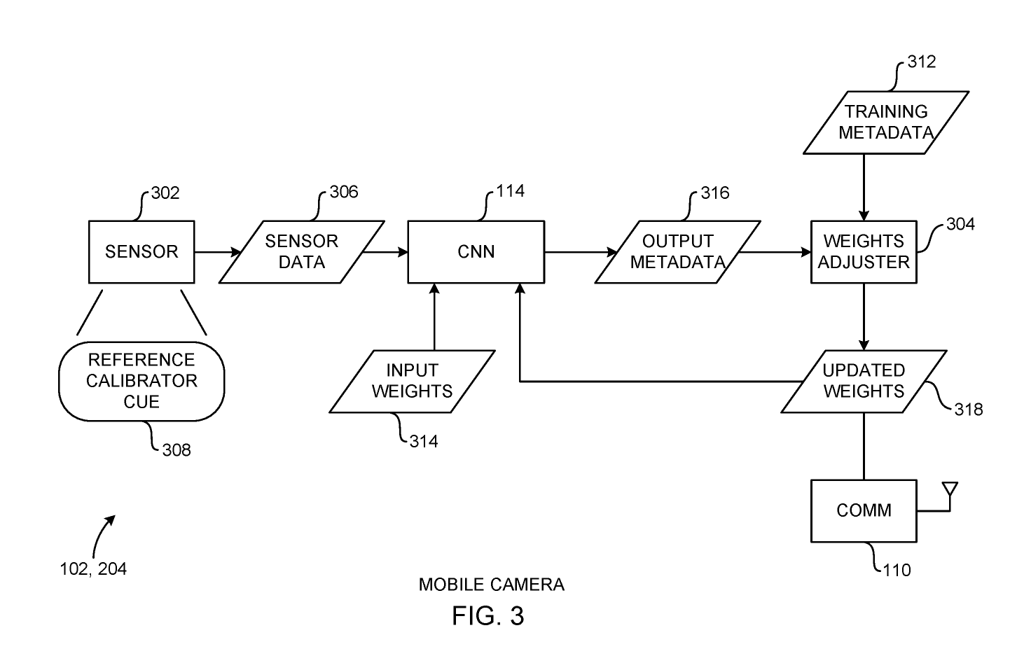

The example VPU 108 trains its CNNs 114 based on sensor data and corresponding metadata to generate CNN network weights 122 (e.g., weights W₀-W₃) that the CNNs 114 can subsequently use to recognize features in subsequent sensor data. Example CNN training is described below in connection with FIG. 3. In the illustrated example, the CNN network weights 122 are stored in one or more memories or data stores shown in FIG. 1A as a double data rate (DDR) synchronous dynamic random access memory (SDRAM) 124, a RAM memory 126 (e.g., a dynamic RAM (DRAM), a static RAM (SRAM), etc.), and a CNN store 128 (e.g., nonvolatile memory). Any other suitable storage device may additionally or alternatively be used.

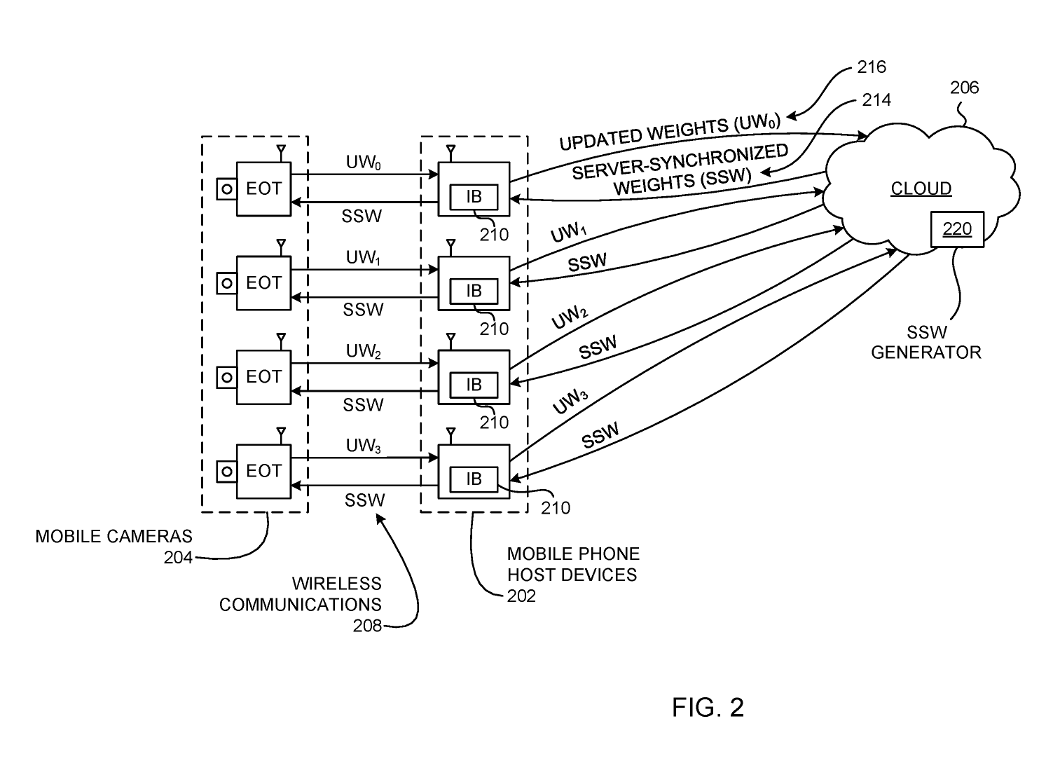

The example wireless communication interface 110 may be implemented using any suitable wireless communication protocol such as the Wi-Fi wireless communication protocol, the Bluetooth® wireless communication protocol, the Zigbee® wireless communication protocol, etc. The wireless communication interface 110 may be used to communicate with a host device (e.g., one of the mobile phone host devices 202 of FIG. 2) and/or other mobile cameras via client/server communications and/or peer-to-peer communications.

FIG. 2 illustrates example mobile phone host devices 202 in wireless communication with corresponding example mobile cameras 204 and an example cloud system 206. In the illustrated example of FIG. 2, the mobile phone host devices 202 serve as host devices to receive information from and send information to the example mobile cameras 204. The mobile phone host devices 202 also communicatively connect the mobile cameras 204 to a cloud service provided by the cloud system 206. Although the host devices 202 are shown as mobile phones, in other examples host devices 202 may be implemented using any other type of computing device including smartwatch or other wearable computing devices, tablet computing devices, laptop computing devices, desktop computing devices, Internet appliances, Internet of Things (loT) devices, etc. The example mobile cameras 204 are substantially similar or identical to the mobile camera 100 of FIGS. 1A and 1B.

In the illustrated example of FIG. 2, the mobile cameras 204 wirelessly communicate with their corresponding mobile phone host devices 202 using wireless communications 208 via wireless communication interfaces such as the wireless communication interface 110 of FIGS. 1A and 1B. In addition, the example mobile phone host devices 202 communicate wirelessly with the cloud system 206 via, for example, a cellular network, a Wi-Fi, or any other suitable wireless communication means. In any case, the mobile phone host devices 202 and the cloud system 206 communicate via a public network such as the Internet and/or via a private network. In some examples, the mobile cameras 204 may be configured to communicate directly with the cloud system 206 without an intervening host device 202. In yet other examples, a host device 202 may be combined with a mobile camera 204 in a same device or housing.

In examples disclosed herein, the mobile phone host devices 202 are provided with example information brokers (IBs) 210 to transfer information between mobile cameras 204 and a cloud service provided by the cloud system 206. In the illustrated example, the information brokers 210 are implemented using an MQTT (Message Queue Telemetry Transport) protocol. The MQTT protocol is an ISO standard (ISO/IEC PRF 20922) publish-subscribe-based messaging protocol that works on top of the TCP/IP protocol. In examples disclosed herein, the MQTT protocol can be used as a lightweight messaging protocol for small sensors (e.g., the mobile cameras 204) and mobile devices (e.g., the mobile phone host devices 202) to handle communications for high-latency and/or unreliable networks. In this manner, examples disclosed herein can employ the MQTT protocol as a low-power and low-bandwidth communication protocol to maintain efficient and reliable communications between the mobile cameras 204 and the mobile phone host devices 202 using peer-to-peer (P2P) communications and/or for exchanging information such as CNN network weights with cloud services or other networked devices. Using the information brokers 210, lightweight communications can be used to send lightweight data (e.g., CNN network weights) from the mobile cameras 204 and/or the mobile phone host devices 202 to a cloud service. In such examples, the mobile cameras 204 can their CNNs 114 (FIG. 1A) at the edge of a network and consume fewer amounts of network bandwidth to transfer resulting CNN network weights (e.g., updated weights 216 described below) instead of transferring raw sensor data to the cloud system 206 for processing at the cloud system 206.

The example cloud system 206 is implemented using a plurality of distributed computing nodes and/or storage nodes in communication with one another and/or with server hosts via a cloud-based network infrastructure. The example cloud system 206 provides cloud services to be accessed by the mobile phone host devices 202 and/or the mobile cameras 204. An example cloud service for use with examples disclosed herein includes a CNN network weight generating and distributing service. For example, as shown in FIG. 2, the cloud system 206 can generate and send server-synchronized weight values (SSWs) 214 to the mobile phone host devices 202 for use by CNNs (e.g., the CNNs 114) of the mobile cameras 204. In the illustrated example, the cloud system 206 can send the SSWs 214 to the mobile phone host devices 202 using any suitable transmission technique including, for example, broadcasting the SSWs 214, multicasting the SSWs 214, and/or unicasting the SSWs 214 to the mobile phone host devices 202. In some examples, the cloud system 206 also sends the CNNs 114 (FIG. 1A) to the mobile cameras 204. For example, the cloud system 206 may send CNNs 114 to the mobile cameras 204 every time the cloud system 206 sends the SSWs 214. Alternatively, the cloud system 206 may send the CNNs 114 only when updates to structures of the CNNs 114 are available for distribution. Updates to structures of the CNNs 114 include, for example, a configuration change in a number of neurons (e.g., nodes) in CNNs 114, a configuration change in how the neurons are connected in the CNNs 114, a configuration change in how neurons are arranged in the CNNs 114, etc. In some examples, the cloud system 206 may send only a portion of a CNN 114 that has been updated.

In the illustrated example of FIG. 2, the mobile cameras 204 train the CNNs 114 to generate updated CNN network weights shown in FIG. 2 as updated weights 216 (e.g., UW₀-UW₃). The example updated weights 216 may implement the CNN network weights 122 shown in FIG. 1A. The example mobile cameras 204 generate the updated weights 216 based on their individual feature recognition capabilities and/or based on environmental characteristics in which the mobile cameras 204 operate. For example, CNN training for audio feature recognition by a mobile camera 204 working in a quiet library environment may result in generating updated weights 216 that are different than updated weights 216 from a mobile camera 204 working in a noisy industrial environment.

In the illustrated example of FIG. 2, the mobile cameras 204 send their updated weights 216 to the cloud system 206 (e.g., via the mobile phone host devices 202). In this manner, while the SSWs 214 may be distributed as the same sets of the CNN network weights to all the mobile cameras 204, each mobile camera 204 may return a different set of updated weights 216 to the cloud system 206 based on the separate CNN trainings performed by each mobile camera 204. In some examples, to conserve network bandwidth and to conserve power needed by the mobile cameras 204 for transmitting information, the mobile cameras 204 send to the cloud system 206 only ones of the updated weights 216 that are different from corresponding ones of the SSWs 214.

In the illustrated example, the cloud system 220 is provided with an example SSW generator 220 to generate the SSWs 214 and/or different CNNs 114 for sending to the mobile cameras 100, 204. The example SSW generator 220 can be implemented in a cloud server of the cloud system 206 to store and use the collected updated weights 216 from the mobile cameras 204 to generate improved CNN network weights that the cloud system 206 can send to the same mobile cameras 204 or different mobile cameras as the SSWs 214 to enhance feature recognition capabilities at the mobile cameras. In some examples, the SSW generator 220 generates different SSWs 214 for different groupings or subsets of mobile cameras 204. For example, the SSW generator 220 may generate different sets of SSWs 214 targeted for use by different types of mobile cameras 204. Such different types of mobile cameras 204 may differ in their characteristics including one or more of: manufacturer, sensor types, sensor capabilities, sensor qualities, operating environments, operating conditions, age, number of operating hours, etc. In this manner, the SSW generator 220 may generate different sets of SSWs 214 that are specific, or pseudo-specific for use by corresponding mobile cameras 204 based on one or more of their characteristics. In such examples, the SSW generator 220 may send the different sets of SSWs 214 to corresponding groups of mobile cameras 204 based on grouped addresses (e.g., internet protocol (IP) address, media access control (MAC) addresses, etc.) of the mobile cameras 204 and/or based on any other grouping information.

In the illustrated example, the sending of the SSWs 214 from the cloud system 206 to the mobile cameras 204 and the receiving of the updated weights 216 from the mobile cameras 204 at the cloud system 206 is a multi-iteration process through which the SSW generator 220 coordinates refining of CNN network weights that continually improve for use by the mobile cameras 204 over time. In some examples, such adjusting of CNN network weights overtime can improve or maintain recognition accuracies of the mobile cameras 204 as sensors of the mobile cameras 204 degrade/change over time. In some examples, the SSW generator 220 can also use the multiple mobile cameras 204 as a testing platform to test different CNN network weights. For example, as discussed above, the SSW generator 220 may send different sets of SSWs 214 to different groups of mobile cameras 204. In some examples, such different sets of SSWs 214 may be used to determine which SSWs 214 perform the best or better than others based on which of the SSWs 214 result in more accurate feature recognitions at the mobile cameras 204. To implement such testing, the example SSW generator 220 can employ any suitable input-output comparative testing. An example testing technique includes A/B testing, which is sometimes used in testing performances of websites by running two separate instances of a same webpage that differ in one aspect (e.g., a font type, a color scheme, a message, a discount offer, etc.). One or more performance measures (e.g., webpage visits, click-throughs, user purchases, etc.) of the separate webpages are then collected and compared to determine the better implementation of the aspect based on the better-performing measure. Such A/B testing may be employed by the SSW generator 220 to test different sets of the SSWs 214 by sending two different sets of the SSWs 214 to different groups of the mobile cameras 204. The two different sets of the SSWs 214 can differ in one or more CNN network weight(s) to cause the different groups of the mobile cameras 204 to generate different feature recognition results of varying accuracies based on the differing CNN network weight(s). In this manner, the SSW generator 220 can determine which of the different sets of the SSWs 214 performs better based on the resulting feature recognition accuracies. Such A/B testing may be performed by the SSW generator 220 based on any number of sets of the SSWs 214 and based on any number of groups of the mobile cameras 204. In addition, the A/B testing may be performed in a multi-iteration manner by changing different weights across multiple iterations to refine CNN network weights to be distributed as the SSWs 214 to mobile cameras 204 over time.

In some examples, the cloud system 206 may be replaced by a dedicated server-based system and/or any other network-based system in which the mobile cameras 204 and/or the mobile phone host devices 202 communicate with central computing and/or storage devices of the network-based system. The example mobile cameras 204 and the mobile phone host devices 202 are logically located at an edge of a network since they are the endpoints of data communications. In the illustrated example, sensor-based metadata and/or sensor data collected by the mobile cameras 204 is stored and processed at the edge of the network by the mobile cameras 204 to generate the updated weights 216. Training CNNs at the edge of the network based on the specific needs or capabilities of the individual mobile cameras 204 offloads processing requirements from the cloud system 206. For example, processing requirements for CNN training are distributed across multiple mobile cameras 204 so that each mobile camera 204 can use its processing capabilities for CNN training based on its sensor data so that the cloud system 206 need not be equipped with the significant additional CPU (central processing unit) resources, GPU (graphic processing unit) resources, and/or memory resources required to perform such CNN training based on different sensor data received from a large number of networked mobile cameras 204. In addition, CNN training based on different sensor data from each of the mobile cameras 204 can be done faster when performed in parallel at distributed mobile cameras 204 rather than performed in seriatim in a central location such as the cloud system 206.

In addition, by performing the CNN training and generating the updated weights 216 at the mobile cameras 204, and sending the updated weights 216 to a cloud server of the cloud system 206, the mobile cameras 204 need not transmit raw sensor data (e.g., the pixel data, the audio data, and/or the motion data) to the cloud system 206 for CNN based on such raw sensor data at the cloud system 206. In this manner, in terms of visual captures, identities or privacies of individuals and/or private/personal property appearing in visual captures are not inadvertently exposed to other networked devices or computers connected to the Internet that may maliciously or inadvertently access such visual captures during transmission across the Internet. Such privacy protection associated with transmitting the updated weights 216 instead of raw visual captures is useful to provide mobile cameras that comply with government and/or industry regulations regarding privacy protections of personal information (e.g., the EU GDPR regulation on data privacy laws across Europe). In some examples, the updated weights 216 can be encrypted and coded for additional security. In addition, since the updated weights 216 are smaller in data size than raw sensor data, sending the updated weights 216 significantly reduces power consumption because transmitting the raw sensor data would require higher levels of power.

FIG. 3 illustrates an example implementation of the mobile cameras 100, 204 of FIGS. 1A, 1B, and 2 that may be used to train corresponding CNNs (e.g., the CNNs 114 of FIG. 1A) and generate updated weight values (e.g., the updated weights 216 of FIG. 2) for use with feature recognition processes of the CNNs to identify features based on sensor data. The example mobile camera 100, 204 of FIG. 3 includes an example sensor 302, an example CNN 114, an example weights adjuster 304, and the example wireless communication interface 110. Although only one sensor 302 and one CNN 114 are shown in the illustrated example of FIG. 3, the mobile camera 100, 204 may be provided with any number of sensors 302 and/or CNNs 114. For example, the mobile camera 100, 204 may be provided with one or more camera sensors, one or more microphones, one or more motion sensors, etc. and/or one or more CNNs 114 to process different types of sensor data (e.g., visual captures, audio data, motion data, etc.).

In the illustrated example, to train the CNN 114, the sensor 302 generates sensor data 306 based on a reference calibrator cue 308. The example reference calibrator cue 308 may be a predefined image, audio clip, or motion that is intended to produce a response by the CNN 114 that matches example training metadata 312 describing features of the reference calibrator cue 308 such as an object, a person, an audio feature, a type of movement, an animal, etc. The example reference calibrator cue 308 may be provided by a manufacturer, reseller, service, provider, app developer, and/or any other party associated with development, resale, or a service of the mobile camera 100, 204. Although a single reference calibrator cue 308 is shown, any number of one or more different types of reference calibrator cues 308 may be provided to train multiple CNNs 114 of the mobile camera 100, 204 based on different types of sensors 302 (e.g., camera sensors, microphones, motion sensors, etc.). For example, if the sensor 302 is a camera sensor (e.g., one of the cameras 100, 204 of FIGS. 1A, 1B, and 2), the reference calibrator cue 308 is an image including known features described by the training metadata 312. If the sensor 302 is a microphone (e.g., the microphone 162 of FIG. 1B), the reference calibrator cue 308 is an audio clip (e.g., an audio file played back by a device such as a mobile phone host device 202 of FIG. 2) including known features described by the training metadata 312. If the sensor 302 is an accelerometer, a gyroscope, a magnetometer, etc., the reference calibrator cue 308 is a known motion induced on the mobile camera 100, 204 (e.g., by a person) and that is representative of a feature (e.g., walking, jumping, turning, etc.) described by the training metadata 312.

In the illustrated example of FIG. 3, the CNN 114 receives the sensor data 306 and input weight values 314 during a CNN training process to generate improved CNN weight values. The input weights 314 of the illustrated example are implemented using the SSWs 214 received from the cloud system 206 shown in FIG. 2. The example CNN 114 loads the input weights 314 into its neurons and processes the sensor data 306 based on the input weights 314 to recognize features in the sensor data 306. Based on the input weights 314, the CNN 114 generates different probabilities corresponding to likelihoods of different features being present in the sensor data 306. Based on such probabilities, the CNN 114 generates output metadata 316 describing features that it confirms as being present in the sensor data 306 based on corresponding probability values that satisfy a threshold.

The weights adjuster 304 of the illustrated example may be implemented by the VPU 108 of FIGS. 1A and 1B. The example weights adjuster 304 receives the output metadata 316 from the example CNN 114 and accesses the example training metadata 312 from, for example, a memory or data store (e.g., the example DDR SDRAM 124, the RAM memory 126, and/or the CNN store 128 of FIG. 1A). The example weights adjuster 304 compares the output metadata 316 to the training metadata 312 to determine whether the response of the CNN 114 accurately identifies features in the reference calibrator cue 308. When the output metadata 316 does not match the training metadata 312, the weights adjuster 304 adjusts the weight values of the input weights 314 to generate updated weight values shown in FIG. 3 as updated weights 318. As such, the updated weights 318 are the learned responses of the CNN 114 during a CNN training process to improve the feature recognition capabilities of the CNN 114 so that the CNN 114 can correctly identify objects, people, faces, events, etc. of the class it has been trained on to output accurate corresponding metadata (e.g., this is a dog, this is a cat, this is a breed of dog/cat, this is a person, this is a particular person, this is a vehicle, this is a particular make/model of vehicle, this person is running, this person is jumping, this person is sleeping, etc.). For example, the weights adjuster 304 can increase and/or decrease weight values to change recognition sensitivities/accuracies corresponding to features that should be recognized in the reference calibrator cue 308 by increasing probabilities determined by the CNN 114 of the likelihood that such features are present in the reference calibrator cue 308 and/or by decreasing probabilities determined by the CNN 114 of the likelihood that other, non-existent features are present in the reference calibrator cue 308.

As part of the training of the CNN 114 and the development of improved CNN weight values, the example weights adjuster 304 provides the updated weights 318 to the CNN 114 to re-analyze the sensor data 306 based on the updated weights 318. The weight adjusting process of the weights adjuster 304 is performed as an iterative process in which the weights adjuster 304 compares the training metadata 312 to the output metadata 316 from the CNN 114 corresponding to different updated weights 318 until the output metadata 316 matches the training metadata 312. In the illustrated example, when the weights adjuster 304 determines that the output metadata 316 matches the training metadata 312, the weights adjuster 304 provides the updated weights 318 to the wireless communication interface 110. The example wireless communication interface 110 sends the updated weights 318 to the cloud system 206 of FIG. 2. For example, the updated weights 318 sent by the wireless communication interface 110 to the cloud system 206 implement the updated weights 216 of FIG. 2 that are communicated to the cloud system 206 directly from the mobile cameras 204 and/or via corresponding mobile phone host devices 202.

An example in-device learning process that may be implemented during CNN training of the CNN 114 includes developing a CNN-based auto white balance (AWB) recognition feature of a mobile camera 100, 204. An existing non-CNN AWB algorithm in the mobile camera 100, 204 can be used to generate labels (e.g., metadata describing AWB algorithm settings) for images captured by the mobile camera 100, 204 and combine the labels with the raw images that were used by the existing non-CNN AWB algorithm to produce the labels. This combination of labels and raw image data can be used for in-device training of the CNN 114 in the mobile camera 100, 204. The resulting CNN network weights from the CNN 114 can be sent as updated weights 216, 318 to the cloud system 206 and can be aggregated with other updated weights 216 generated across multiple other mobile cameras 100, 204 to produce a CNN network and SSWs 214 at the cloud system 206 that provide an AWB performance across local lighting conditions that satisfies an AWB performance threshold such that the CNN-based AWB implementation can replace prior non-CNN AWB algorithms. An example AWB performance threshold may be based on a suitable or desired level of performance relative to the performance of a non-CNN AWB algorithm. Such example in-device learning process and subsequent aggregation of CNN network weights at the cloud system 206 can be performed without needing to send raw sensor data from the mobile camera 100, 204 to the cloud system 206.

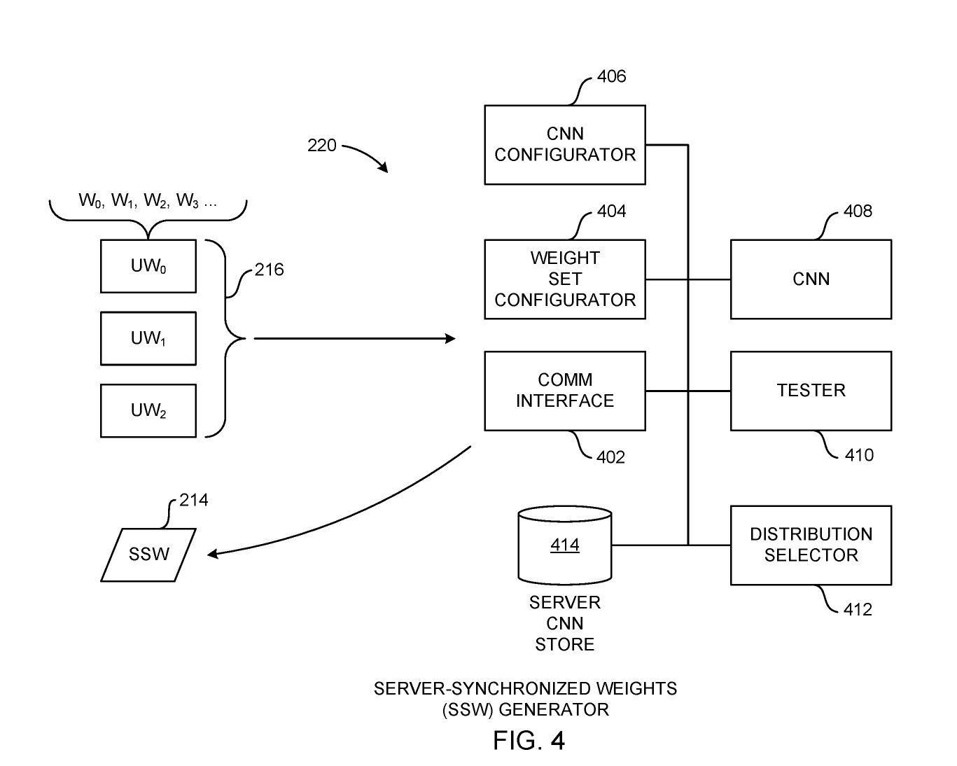

FIG. 4 illustrates an example implementation of the server-synchronized weights (SSW) generator 220 of FIG. 2 that may be implemented in a server or computer of the cloud system 206 (FIG. 2) to generate the server-synchronized weights 214 (FIG. 2) for use in the CNNs 114 of the mobile cameras 100, 204 of FIGS. 1A, 1B, 2, and 3. The example SSW generator 220 includes an example communication interface 402, an example weight set configurator 404, an example CNN configurator 406, an example CNN 408, an example tester 410, an example distribution selector 412, and an example server CNN store 414. The example communication interface 402 may be implemented using any suitable wired (e.g., a local area network (LAN) interface, a wide area network (WAN) interface, etc.) or wireless communication interface (e.g., a cellular network interface, a Wi-Fi wireless interface, etc.). In the illustrated example, the communication interface 402 sends the SSWs 214 to the mobile cameras 100, 204 of FIGS. 1A, 1B, 2, and 3 as described above in connection with FIG. 2. For example, the communication interface 402 may broadcast, multicast, and/or unicast the SSWs 214 directly to the mobile cameras 100, 204 and/or via the mobile phone host devices 202 to the mobile cameras 100, 204. The example communication interface 402 also receives the updated weights 216 from the mobile cameras 100, 204 and/or from the mobile phone host devices 202 as described above in connection with FIG. 2.

The example weight set configurator 404 is provided to adjust and configure CNN weight values based on the updated weights 216 to generate the SSWs 214. For example, the weight set configurator 404 may select and fuse/combine individual CNN network weight values from different sets of updated weights 216 from different mobile cameras 100, 204 to create new sets of CNN network weights and/or multiple sets of CNN network weights that can be tested by the SSW generator 220. In this manner, the SSW generator 220 can learn which set(s) of fused/combined CNN network weights are likely to perform better than others in the mobile cameras 100, 204.

The example SSW generator 220 is provided with the example CNN configurator 406 to generate different CNNs by, for example, configuring different structural arrangements of neurons (e.g., nodes), configuring or changing the number of neurons in a CNN, configuring or changing how the neurons are connected, etc. In this manner, in addition to generating improved CNN network weight values, the example SSW generator 220 may also generate improved CNNs for use at the mobile cameras 100, 204 with the improved CNN network weight values. Thus, although only one CNN 408 is shown in FIG. 4, the SSW generator 220 may generate and test a plurality of

CNNs 408. The example SSW generator 220 uses the example CNNs 408 to run feature recognition processes based on different sets of CNN network weight values provided by the weight set configurator 404. For example, a CNN 408 may be provided with input training sensor data similar or identical to the sensor data 306 of FIG. 3 and perform feature recognition processes on the input training sensor data based on the CNN network weight values to generate output metadata describing features that the CNN 408 confirms as being present in the input training sensor data based on the CNN network weight values.

The example SSW generator 220 is provided with the tester 410 to test performances of the different set of CNN network weight values generated by the weight set configurator 404 and/or different CNNs 408 generated by the CNN configurator 406. In examples disclosed herein, performance tests are used to determine whether sets of CNN network weights and/or one or more structures of the CNNs satisfy a feature-recognition accuracy threshold by accurately identifying features present in input data (e.g., sensor data, input training sensor data, etc.) and/or by not identifying features that are not present in the input data. For example, the tester 410 may compare the output metadata from a CNN 408 to training metadata (e.g., similar or identical to the training metadata 312 of FIG. 3) to determine whether the response of the CNN 408 accurately identifies features in the input training sensor data. When the example tester 410 determines that the output metadata of the CNN 408 does not match the training metadata, the weight set configurator 404 adjusts weight values and/or selects different combinations of CNN network weights to generate a different set of CNN network weights to be tested in the CNN 408. For example, the weight set configurator 404 can increase and/or decrease weight values to change recognition sensitivities/accuracies corresponding to features that should be recognized in the input training sensor data by increasing probabilities determined by the CNN 408 of the likelihood that such features are present in the input training sensor data and/or by decreasing probabilities determined by the CNN 408 of the likelihood that other, non-existent features are present in the input training sensor data. Additionally or alternatively, the CNN configurator 406 can change a structure of the CNN 408 for testing with the same or a different set of CNN network weights. In this manner, the tester 410 may test different combinations of sets of CNN network weights and structures of the CNN 408 to identify one or more sets of CNN network weights and/or one or more structures of the CNN 408 that satisfy a feature-recognition accuracy threshold so that such set(s) of CNN network weights and/or structure(s) of the CNN 408 can be distributed to the mobile cameras 100, 204.

The weight set configurator 404, the CNN 408, and the tester 410 can perform multiple CNN training processes in an iterative manner to determine one or more sets of CNN network weight values that perform satisfactorily and/or better than other sets of CNN network weight values. Using such an iterative CNN training process, the SSW generator 220 can determine one or more sets of CNN network weight values that can be sent to mobile cameras 100, 204 for use with their corresponding CNNs 114. In this manner, fused/combined sets of CNN network weight values and the CNN 408 can be used to train CNNs 114 of the mobile cameras 100, 204 without needing to access sensor data (e.g., the sensor data 306) generated by the mobile cameras 100, 204. Such training at the cloud system 206 without needing to receive large amounts of sensor data from mobile cameras 100, 204 can be usefully employed to avoid using significant amounts of network bandwidth that would otherwise be needed to receive sensor data at the cloud system 206 from the mobile cameras 100, 204.

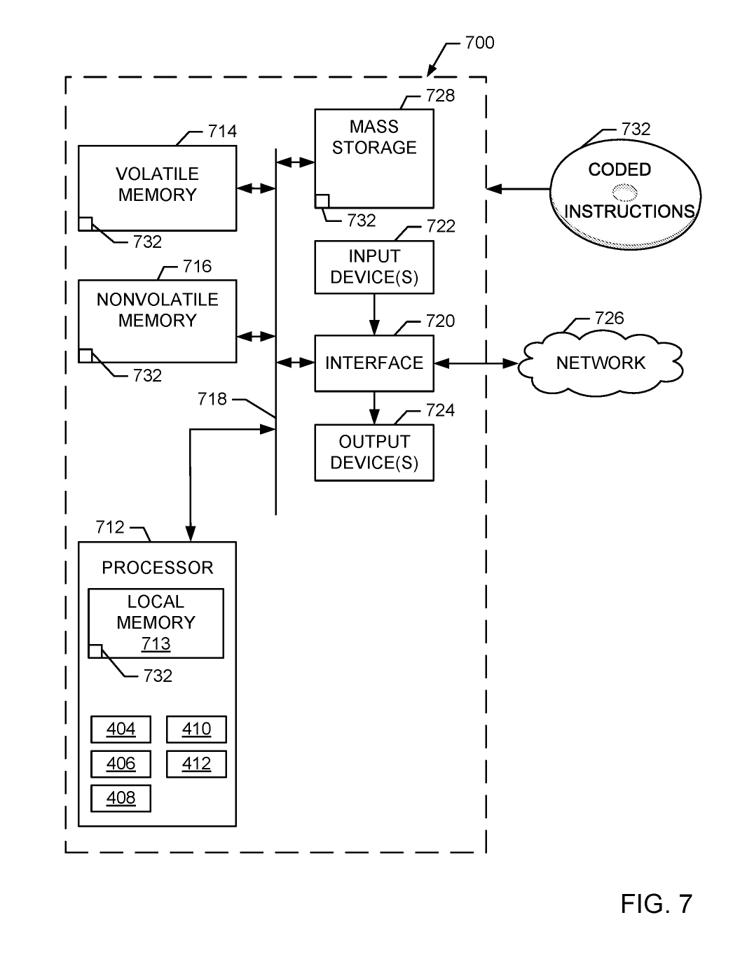

The example tester 410 may store sets of CNN network weight values and/or CNNs 408 that satisfy a feature-recognition accuracy threshold in the server CNN store 414. The example tester 410 may store a tag, flag, or other indicator in association with the sets of CNN network weight values in the server CNN store 414 to identify those sets of CNN network weight values as usable for distributing to the mobile cameras 100, 204 as the SSWs 214 as described above in connection with FIG. 2. The example tester 410 may also store a tag, flag, or other indicator in association with the CNNs 408 in the server CNN store 414 to identify those CNNs 408 as usable for distributing to the mobile cameras 100, 204 as described above in connection with FIG. 2. The example server CNN store 414 may be implemented using any suitable memory device and/or storage device (e.g., one or more of the local memory 713, the volatile memory 714, the nonvolatile memory 716, and/or the mass storage 728 of FIG. 7).

In the illustrated example of FIG. 4, the SSW generator 220 is provided with the example distribution selector 412 to select ones of the tested sets of CNN network weight values and/or CNNs 408 identified in the server CNN store 414 as being suitable for use in the mobile cameras 100, 204 to accurately identify features in sensor data. The example distribution selector 412 provides the selected ones of the tested sets of CNN network weight values and/or CNNs 408 from the server CNN store 414 to the communication interface 402 for sending to the mobile cameras 100, 204. The example communication interface 402 sends the selected ones of the tested sets of CNN network weight values to the mobile cameras 100, 204 as the SSW 214 as described above in connection with FIG. 2. In some examples, the distribution selector 412 selects different ones of the tested sets of CNN network weight values and/or different CNNs 408 from the server CNN store 414 for different groups of mobile cameras 100, 204 based on different criteria or characteristics corresponding to those groups of mobile cameras 100, 204 as described above in connection with FIG. 2.

In some examples, to confirm the viability or accuracy of the sets of CNN network weight values and/or the CNNs 408, the distribution selector 412 can select different ones of the tested sets of CNN network weight values from the server CNN store 414 to send to different mobile cameras 100, 204 to perform comparative field testing of the weights. For example, such field testing may involve performing A/B testing of the different sets of CNN network weights at different mobile cameras 100, 204 as described above in connection with FIG. 2. The distribution selector 412 can similarly select different CNNs 408 from the server CNN store 414 for distributing to different mobile cameras 100, 204 to perform similar types of comparative testing of the different CNNs 408 in the field. In this manner, different CNN network weight values and/or different CNNs can be tested across a large number of mobile cameras 100, 204 to further refine CNN network weight values and/or CNNs.

While an example manner of implementing the mobile cameras 100, 204 is illustrated in of FIGS. 1A, 1B, 2, and 3, and an example manner of implementing the SSW generator 220 is illustrated in FIGS. 2 and 4, one or more of the elements, processes and/or devices illustrated in FIGS. 1A, 1B, 2, 3, and/or 4 may be combined, divided, re-arranged, omitted, eliminated and/or implemented in any other way. Further, the example inertial measurement unit 104 (FIGS. 1A and 1B), the example audio codec 106 (FIGS. 1A and 1B), the example VPU 108 (FIGS. 1A and 1B), the example CNN 114 (FIG. 1A and 3), the example computer vision analyzer(s) 116 (FIG. 1A), the example DSP 118 (FIG. 1A), the example wireless communication interface 110 (FIGS. 1A, 1B, and 3), the example sensor 302 (FIG. 3), the example weights adjuster (FIG. 3), and/or, more generally, the example mobile camera 100, 204, and/or the example communication interface 402 (FIG. 4), the example weight set configurator 404 (FIG. 4), the example CNN configurator 406 (FIG. 4), the example CNN 408 (FIG. 4), the example tester 410 (FIG. 4), the example distribution selector 412 (FIG. 4), and/or more generally the example SSW generator 220 of FIGS. 2 and 4 may be implemented by hardware, software, firmware and/or any combination of hardware, software and/or firmware. Thus, for example, any of the example inertial measurement unit 104, the example audio codec 106, the example VPU 108, the example CNN 114, the example computer vision analyzer(s) 116, the example DSP 118, the example wireless communication interface 110, the example sensor 302, the example weights adjuster, and/or, more generally, the example mobile camera 100, 204, and/or the example communication interface 402, the example weight set configurator 404, the example CNN configurator 406, the example CNN 408, the example tester 410, the example distribution selector 412, and/or, more generally, the SSW generator 220 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the example inertial measurement unit 104, the example audio codec 106, the example VPU 108, the example CNN 114, the example computer vision analyzer(s) 116, the example DSP 118, the example wireless communication interface 110, the example sensor 302, the example weights adjuster, the example communication interface 402, the example weight set configurator 404, the example CNN configurator 406, the example CNN 408, the example tester 410, and/or the example distribution selector 412 is/are hereby expressly defined to include a non-transitory computer readable storage device or storage disk such as a memory, a digital versatile disk (DVD), a compact disk (CD), a Blu-ray disk, etc. including the software and/or firmware. Further still, the example mobile camera 100, 204 of FIGS. 1A, 1B, 2, and 3 and/or the example SSW generator 220 of FIGS. 2 and 4 may include one or more elements, processes and/or devices in addition to, or instead of, those illustrated in FIGS. 1A, 1B, 2, 3 and/or 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

In some examples disclosed herein, means for communicating may be implemented using the communication interface 402 of FIG. 4. In some examples disclosed herein, means for configuring weight values may be implemented using the weight set configurator 404. In some examples disclosed herein, means for configuring a structure of a convolutional neural network may be implemented using the CNN configurator 406. In some examples, means for performing feature recognition may be implemented using the CNN 408. In some examples disclosed herein, means for testing may be implemented using the tester 410 of FIG. 4. In some examples disclosed herein, means for selecting may be implemented using the distribution selector 412 of FIG. 4.

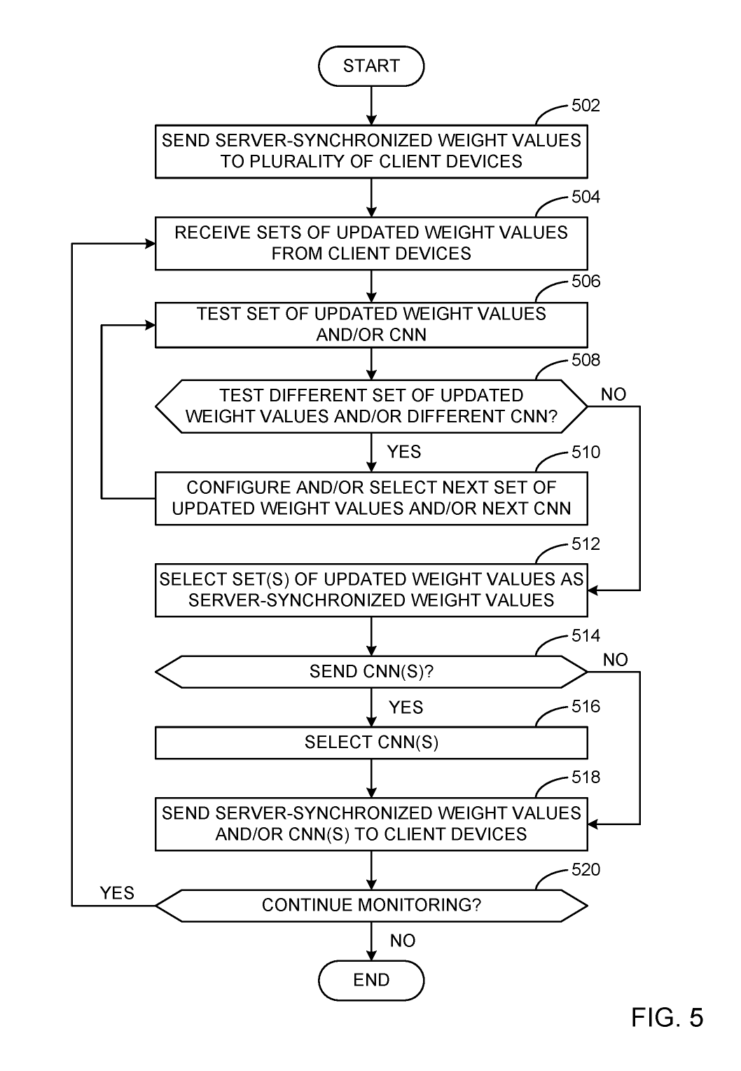

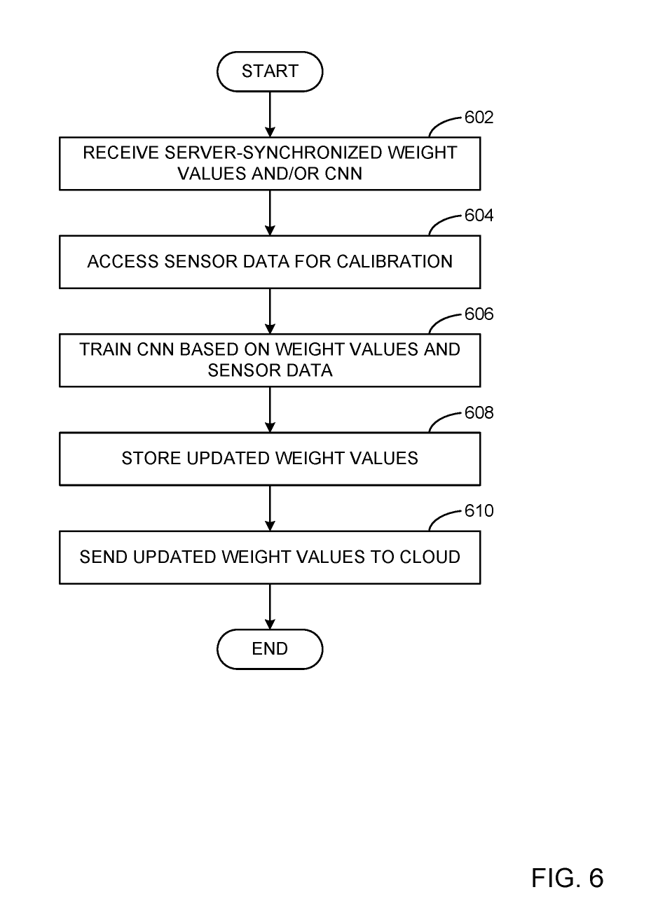

A flowchart representative of example hardware logic or machine-readable instructions for implementing the example SSW generator 220 of FIGS. 2 and 4 is shown in FIG. 5. A flowchart representative of example hardware logic or machine-readable instructions for implementing the mobile camera 100, 204 of FIGS. 1A, 1B, 2, and 3 is shown in FIG. 6. The machine-readable instructions may be programs or portions of programs for execution by a processor such as the VPU 108 discussed above in connection with FIGS. 1A and 1B and/or the processor 712 shown in the example processor platform 700 discussed below in connection with FIG. 7. The program(s) may be embodied in software stored on a non-transitory computer readable storage medium such as a CD-ROM, a floppy disk, a hard drive, a DVD, a Blu-ray disk, or a memory associated with the VPU 108 and/or the processor 712, but the entirety of the program(s) and/or parts thereof could alternatively be executed by a device other than the VPU 108 or the processor 712 and/or embodied in firmware or dedicated hardware. Further, although the example program(s) is/are described with reference to the flowcharts illustrated in FIGS. 5 and 6, many other methods of implementing the example mobile cameras 100, 204 and/or the SSW generator 220 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 5 and 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including ” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

FIG. 5 illustrates a flowchart representative of example machine-readable instructions that may be executed to implement the SSW generator 220 of FIGS. 2 and 4 to generate the SSWs 214 (FIGS. 2 and 4) for use in CNNs (e.g., the CNN 114 of FIGS. 1A and 3) of the mobile cameras 100, 204 of FIGS. 1A, 1B, 2, and 3. The example program of FIG. 5 begins at block 502 at which the example communication interface 402 (FIG. 4) sends the SSWs 214 to a plurality of client devices. For example, the communication interface 402 can send the SSWs 214 to the mobile cameras 100, 204 via any private or public network. The example communication interface 402 receives sets of the updated weights 216 from the client devices (block 504). For example, the communication interface 402 receives the updated weights 216 from the mobile cameras 100, 204 via the private or public network. In the illustrated example, the updated weights 216 are generated by the mobile cameras 100, 204 training respective CNNs 114 based on: (a) the SSWs 214, and (b) the sensor data 306 (FIG. 3) generated at the mobile cameras 100, 204.

The example tester 410 (FIG. 4) tests a set of the updated weights 216 and/or a CNN (block 506). For example, the tester 410 uses the CNN 408 (FIG. 4) to test performance for feature recognition of at least one of: (a) a set of the updated weights 216, (b) a combination generated by the weight set configurator 404 (FIG. 4) of ones of the updated weights 216 from different ones of the received sets of the updated weights 216, or (c) adjusted weight values generated by the weight set configurator 404. In some examples, the tester 410 also tests a feature recognition performance of a structure of the CNN 408 at block 506. An example performance test may be used to determine whether the tested CNN network weights and/or the tested CNN satisfy a feature-recognition accuracy threshold by accurately identifying features present in input data (e.g., sensor data, input training sensor data, etc.) and/or by not identifying features that are not present in the input data. The example tester 410 determines whether to test a different set of updated weights 216 and/or a different CNN 408 (block 508). For example, if the tester 410 determines that the tested set of updated weights 216 and/or the tested CNN 408 do(es) not satisfy a feature-recognition accuracy threshold to accurately identify features in input training sensor data, the tester 410 determines that it should test a different set of updated weights 216 and/or a different structure for the CNN 408. If the example tester 410 determines at block 508 to test a different set of updated weights 216 and/or a different structure for the CNN 408, control advances to block 510 at which the weight set configurator 404 (FIG. 4) configures and/or selects a next set of the updated weights 216. Additionally or alternatively at block 510, the CNN configurator 406 may configure a next CNN structure for the CNN 408.

If the example tester 410 determines at block 508 not to test a different set of updated weights 216 and not to test a different structure for the CNN 408, control advances to block 512 at which the example distribution selector 412 selects one or more set(s) of updated weights 216 as the SSWs 214. For example, the distribution selector 412 may select a single set of updated weights 216 for distributing as the SSWs 214 to all of the mobile cameras 100, 204 or may select multiple sets of updated weights 216 so that different ones of the sets of updated weights 216 can be distributed as the SSWs 214 to different groups of the mobile cameras 100, 204. In the illustrated example, the distribution selector 412 selects the set(s) of updated weights 216 for use as the SSWs 214 based on the testing performed by the tester 410 and, thus, selects the set(s) of updated weights 216 from at least one of: (a) the sets of the updated weights 216, (b) a combination generated by the weight set configurator 404 of ones of the updated weights 216 from different ones of the received sets of the updated weights 216, or (c) adjusted weight values generated by the weight set configurator 404.

The example distribution selector 412 determines whether to send one or more CNN(s) 408 to the mobile cameras 100, 204 (block 514). For example, the distribution selector 412 may determine to not distribute any CNNs 408, to distribute a single CNN 408 to all the mobile cameras 100, 204, or to distribute different CNNs 408 to different groups of the mobile cameras 100, 204 based on whether there are any CNN structure configurations stored in the server CNN store 414 that are flagged, tagged, or otherwise indicated as suitable/ready for distribution. If the example distribution selector 412 determines at block 514 to send one or more CNNs 408 to the mobile cameras 100, 204, control advances to block 516 at which the distribution selector 412 selects one or more CNNs 408 for distributing. Otherwise, if the example distribution selector 412 determines at block 514 not to send CNN(s) 408 to the mobile cameras 100, 204, control advances to block 518.

The example communication interface 402 sends the SSWs 214 and/or the CNN(s) 408 to the client devices (block 518). For example, the communication interface 402 sends the SSWs 214 selected at block 512 and/or the CNN(s) 408 selected at block 516 to at least one of: (a) at least some of the mobile cameras 100, 204 from which the communication interface 402 received the updated weights 216, or (b) second mobile cameras and/or other client devices that are separate from the mobile cameras 100, 204. For example, the communication interface 402 may send the SSWs 214 and/or the CNN(s) 408 to other client devices that are new and have not undergone in-device CNN training, to other client devices that do not perform in-device CNN training, to other client devices that have recently enrolled in a CNN synchronization service of the cloud system 206 and did not previously provide updated weights 206 to the cloud system 206, and/or to any other client devices that are not part of the mobile cameras 100, 204 from which the communication interface 402 received the updated weights 216 at block 504. In some examples in which CNN(s) 408 are sent, the communication interface 402 sends only portions of the CNN(s) 408 that have been changed, re-configured, or updated relative to CNN(s) already at the client devices. The example communication interface 402 determines whether to continue monitoring for updated weights 216 from the mobile cameras 100, 204 (block 520). If the example communication interface 402 determines at block 520 that it should continue monitoring, control returns to block 504. Otherwise, if the example communication interface 402 determines at block 520 that it should not continue monitoring, the example process of FIG. 5 ends.

FIG. 6 illustrates a flowchart representative of example machine-readable instructions that may be executed to implement the mobile cameras 100, 204 of FIGS. 1A, 1B, 2, and 3 and/or the VPU 108 of FIGS. 1A and 1B to generate the updated weights 216, 318 (FIGS. 2 and 3) for use with corresponding CNNs (e.g., the CNN 114 of FIGS. 1A and 3). The example process of FIG. 6 begins at block 602 at which the wireless communication interface 110 (FIGS. 1A, 1B, and 3) receives the SSWs 214 (FIGS. 2 and 4) and/or a CNN (e.g., the CNN 408 of FIG. 4) from the cloud system 206. For example, the wireless communication interface 110 receives the SSWs 214 and/or the CNN 408 from the communication interface 402 of the SSW generator 220 of FIG. 4. In the illustrated example, when a CNN 408 is received at block 602, the received CNN 408 is used to implement the CNN 114 of the mobile camera 100, 204. The example CNN 114 (FIG. 3) accesses the sensor data 306 (FIG. 3) for calibration (block 604). For example, the CNN 114 accesses the sensor data 306 generated by the sensor 302 (FIG. 3) based on the reference calibrator cue 308 (FIG. 3). In the illustrated example, the CNN 114 obtains the sensor data 306 from the IMU 104 (FIG. 1A) if the sensor 302 is a motion sensor, obtains the sensor data 306 from the AC 106 (FIGS. 1A and 1B) if the sensor 302 is a microphone 162 (FIG. 1B), or obtains the sensor data 306 from one of the cameras 102 (FIGS. 1A and 1B) if the sensor 302 is a camera.

The example weights adjuster 304 trains the CNN 114 based on the input weights 314 (FIG. 3) and the sensor data 306 (block 606). For example, during a first feature recognition process following the receiving of the SSWs 214 at block 602, the input weights 314 are the SSWs 214. However, during a subsequent iteration of the feature recognition process, the input weights 314 are the updated weights 318 (FIG. 3) generated by the weights adjuster 304 when the output metadata 316 (FIG. 3) does not match the training metadata 312 (FIG. 3). When the example weights adjuster 304 determines that the output metadata 316 matches the training metadata 312, the weights adjuster 304 stores the updated weights 318 in a memory or data storage device (block 608). For example, the weights adjuster 304 stores the updated weights 318 in one or more of the example DDR SDRAM 124, the RAM memory 126, and/or the CNN store 128 of FIG. 1A. The wireless communication interface 110 sends the updated weights 318 to the cloud system 206 (block 610). For example, the wireless communication interface 110 sends the updated weights 318 as the updated weights 216 directly to the cloud system 206 or via a corresponding mobile phone host device 202 as described above in connection with FIG. 2. The example process of FIG. 6 then ends.

FIG. 7 illustrates a block diagram of an example processor platform 700 structured to execute the instructions of FIG. 5 to implement the SSW generator 220 of FIGS. 2 and 4. The processor platform 700 can be, for example, a server, a computer, a self-learning machine (e.g., a neural network), an Internet appliance, an loT device, or any other type of computing device. The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor 712 may be a semiconductor based (e.g., silicon based) device. In this example, the processor implements the example weight set configurator 404, the example CNN configurator 406, the example CNN 408, the example tester 410, and the example distribution selector 412 of FIG. 4.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Wi-Fi interface, a Bluetooth® interface, Zigbee® interface, a near field communication (NFC) interface, and/or a PCI express interface. The interface circuit 720 of the illustrated example implements the communication interface 402 of FIG. 4.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a motion sensor, a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or a speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

Machine executable instructions 732 representative of the example machine-readable instructions of FIG. 5 may be stored in the mass storage device 728, in the volatile memory 714, in the non-volatile memory 716, and/or on a removable non-transitory computer readable storage medium such as a CD or DVD.

From the foregoing, it will be appreciated that example methods, apparatus, and articles of manufacture have been disclosed to implement crowd-sourced or federated learning of CNN network weights by collecting large quantities of device-generated CNN network weights from a plurality of client devices and using the collected CNN network weights to generate an improved set of server-synchronized CNN network weights (e.g., server-synchronized weights) at a cloud server or other remote computing device that can access the device-generated CNN network weights.

By sending (e.g., broadcasting, multicasting, etc.) server-synchronized weights to multiple client devices, examples disclosed herein can be used to improve feature recognition process of some client devices by leveraging CNN learning or CNN training performed by other client devices. This can be useful to overcome poor feature recognition capabilities of client devices that have not been properly trained or new client devices that are put into use for the first time and, thus, have not had the opportunities to train as other client devices have had. In addition, training a CNN can require more power than available to a client device at any time or at particular times (e.g., during the day) based on its use model. That is, due to the power requirements, CNN training may be performed only when a client device is plugged into an external power source (e.g., an alternating current (AC) charger). A rechargeable battery-operated client device may only be charged at night or once every few days, in which case CNN training opportunities would be seldom (e.g., when the client device is plugged into a charger). Some client devices may be powered by replaceable non-chargeable batteries, in which case CNN training opportunities may exist only when fully powered fresh batteries are placed in the client devices. Alternatively, CNN training opportunities may not exist for such client devices. In any such case, client devices that have few or no training opportunities can significantly benefit from examples disclosed herein by receiving server-synchronized weights that are based on weights generated by a plurality of other client devices and processed by a cloud server or other remote computing device.

By collecting such device-generated weights to generate improved server-synchronized weights, examples disclosed herein substantially decrease or eliminate the need for cloud servers to collect raw sensor data from the client devices to perform server-based CNN training and CNN network weight testing. That is, although a cloud server could perform CNN training to generate CNN network weights based on raw sensor data collected from client devices, examples disclosed herein eliminate such need by instead crowd-sourcing the device-generated weights from the client devices and using such device-generated weights to generate the improved server-synchronized weights. In this manner, client devices need not transmit raw sensor data to the cloud server. By not transmitting such data, examples disclosed herein are useful to protect privacies of people, real property, and/or personal property that could be reflected in the raw sensor data and/or metadata (e.g., images, voices, spoken words, property identities, etc.). Transmitting device-generated weights from the client devices to the cloud server is substantially more secure than transmitting raw sensor data because if the device-generated weights are intercepted or accessed by a third-party, the weights cannot be reverse engineered to reveal personal private information. As such, examples disclosed herein are particularly useful to protect such personal private information from being divulged to unauthorized parties. In this manner, examples disclosed herein may be used to develop client devices that comply with government and/or industry regulations (e.g., the EU GDPR) regarding privacy protections of personal information. In addition, transmitting device-generated weights from client devices to cloud servers also reduces power consumption of the client devices as a result of needing to transmit less data due to the device-generated weights being of smaller data size than raw sensor data. Such power consumption reduction is especially significant with respect to using Wi-Fi communications, which can be especially demanding on power requirements for performing transmissions.

The following pertain to further examples disclosed herein.

Example 1 is an apparatus to provide weights for use with convolutional neural networks. The apparatus of Example 1 includes a communication interface to: send first weight values to first client devices via a network; and access sets of updated weight values provided by the first client devices via the network, the updated weight values generated by the first client devices training respective first convolutional neural networks based on: (a) the first weight values, and (b) sensor data generated at the first client devices; a tester to test performance in a second convolutional neural network of at least one of: (a) the sets of the updated weight values, or (b) a combination of ones of the updated weight values from the sets of the updated weight values; a distribution selector to, based on the testing, select server-synchronized weight values from the at least one of: (a) the sets of the updated weight values, or (b) the combination of the ones of the updated weight values from the sets of the updated weight values; and the communication interface to send the server-synchronized weight values to at least one of: (a) at least some of the first client devices, or (b) second client devices.

In Example 2, the subject matter of Example 1 can optionally include a convolutional neural network configurator to configure a structure of the second convolutional neural network, and the communication interface is to send at least a portion of the second convolutional neural network to the at least one of: (a) the at least some of the first client devices, or (b) the second client devices.

In Example 3, the subject matter of any one of Examples 1-2 can optionally include that the convolutional neural network configurator is to configure the structure of the second convolutional neural network by at least one of configuring a number of neurons or configuring how the neurons are connected in the second convolutional neural network.

In Example 4, the subject matter of any one of Examples 1-3 can optionally include that the tester is to determine whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

In Example 5, the subject matter of any one of Examples 1-4 an optionally include that the first client devices are mobile cameras.

In Example 6, the subject matter of any one of Examples 1-5 can optionally include that the sensor data generated at the first client devices is at least one of visual capture data, audio data, or motion data.

In Example 7, the subject matter of any one of Examples 1-6 can optionally include that the communication interface, the tester, and the distribution selector are implemented at a server.

Example 8 is directed to an apparatus to provide weights for use with convolutional neural networks. The apparatus of Example 8 includes means for testing performance of at least one of: (a) sets of updated weight values, or (b) a combination of the updated weight values in a first convolutional neural network, the updated weight values obtained from first client devices via a network, the updated weight values generated by the first client devices training respective second convolutional neural networks based on: (a) first weight values, and (b) sensor data generated at the first client devices; and means for selecting server-synchronized weight values from the at least one of: (a) the sets of the updated weight values, or (b) the combination of the updated weight values.

In Example 9, the subject matter of Example 8 can optionally include means for configuring a structure of the second convolutional neural network, and means for communicating to send at least a portion of the second convolutional neural network to the at least one of: (a) the at least some of the first client devices, or (b) the second client devices.

In Example 10, the subject matter of any one of Examples 8-9 can optionally include that the means for configuring the structure is to configure the structure of the second convolutional neural network by at least one of configuring a number of neurons or configuring how the neurons are connected in the second convolutional neural network.

In Example 11, the subject matter of any one of Examples 8-10 can optionally include that the means for testing is to determine whether the at least one of: (a) the sets of the updated weight values, or (b) the combination of the updated weight values satisfies a feature-recognition accuracy threshold by at least one of: (a) accurately identifying features present in input data, or (b) not identifying features that are not present in the input data.

In Example 12, the subject matter of any one of Examples 8-11 can optionally include that the first client devices are mobile cameras.

In Example 13, the subject matter of any one of Examples 8-12 can optionally include that the sensor data generated at the first client devices is at least one of visual capture data, audio data, or motion data.

In Example 14, the subject matter of any one of Examples 8-13 can optionally include means for communicating the first weight values to the first client devices via the network.

Example 15 is directed to a non-transitory computer readable storage medium comprising instructions that, when executed, cause at least one processor to at least send first weight values to first client devices via a network; access sets of updated weight values provided by the first client devices via the network, the updated weight values generated by the first client devices training respective first convolutional neural networks based on: (a) the first weight values, and (b) sensor data generated at the first client devices; test performance in a second convolutional neural network of at least one of: (a) the sets of the updated weight values, or (b) a combination of ones of the updated weight values from the sets of the updated weight values; based on the testing, select server-synchronized weight values from the at least one of: (a) the sets of the updated weight values, or (b) the combination of the ones of the updated weight values from the sets of the updated weight values; and send the server-synchronized weight values to at least one of: (a) at least some of the first client devices, or (b) second client devices.

In Example 16, the subject matter of Example 15 can optionally include that the instructions further cause the at least one processor to: configure a structure of the second convolutional neural network, and send at least a portion of the second convolutional neural network to the at least one of: (a) the at least some of the first client devices, or (b) the second client devices.

In Example 17, the subject matter of any one of Examples 15-16 can optionally include that the instructions further cause the at least one processor to configure the structure of the second convolutional neural network by at least one of configuring a number of neurons or configuring how the neurons are connected in the second convolutional neural network.

In Example 18, the subject matter of any one of Examples 15-17 can optionally include that the of the instructions further cause the at least one processor to determine whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

In Example 19, the subject matter of any one of Examples 15-18 can optionally include that the first client devices are mobile cameras.

In Example 20, the subject matter of any one of Examples 12-15 can optionally include that the sensor data generated at the first client devices is at least one of visual capture data, audio data, or motion data.

Example 21 is directed to a method to provide weights for use with convolutional neural networks. The method of Example 21 includes sending, by a server, first weight values to first client devices via a network; accessing, at the server, sets of updated weight values provided by the first client devices via the network, the updated weight values generated by the first client devices training respective first convolutional neural networks based on: (a) the first weight values, and (b) sensor data generated at the first client devices; testing, by executing an instruction with the server, performance in a second convolutional neural network of at least one of: (a) the sets of the updated weight values, or (b) a combination of ones of the updated weight values from the sets of the updated weight values; selecting based on the testing, by executing an instruction with the server, server-synchronized weight values from the at least one of: (a) the sets of the updated weight values, or (b) a combination of ones of the updated weight values from the sets of the updated weight values; and sending, by the server, the server-synchronized weight values to at least one of: (a) at least some of the first client devices, or (b) second client devices.

In Example 22, the subject matter of Example 21 can optionally include configuring a structure of the second convolutional neural network, and sending at least a portion of the second convolutional neural network to the at least one of: (a) the at least some of the first client devices, or (b) the second client devices.

In Example 23, the subject matter of any one of Examples 21-22 can optionally include that the structure of the second convolutional neural network is configured by at least one of configuring a number of neurons or configuring how the neurons are connected in the second convolutional neural network.

In Example 24, the subject matter of any one of Examples 21-23 can optionally include that the performance is representative of whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

In Example 25, the subject matter of any one of Examples 21-24 can optionally include that the first client devices are mobile cameras.

In Example 26, the subject matter of any one of Examples 21-25 can optionally include that the sensor data generated at the first client devices is at least one of visual capture data, audio data, or motion data.

Example 27 is directed to an apparatus to provide weights for use with convolutional neural networks. The apparatus of Example 27 includes a tester to test performance of at least one of: (a) sets of updated weight values, or (b) a combination of the updated weight values in a first convolutional neural network, the updated weight values obtained from first client devices via a network, the updated weight values generated by the first client devices training respective second convolutional neural networks based on: (a) first weight values, and (b) sensor data generated at the first client devices; and a distribution selector to, based on the testing, select server-synchronized weight values from the at least one of: (a) the sets of the updated weight values, or (b) the combination of the updated weight values.

In Example 28, the subject matter of Example 27 can optionally include a convolutional neural network configurator to configure a structure of the second convolutional neural network, and a communication interface means to send at least a portion of the second convolutional neural network to the at least one of: (a) the at least some of the first client devices, or (b) the second client devices.

In Example 29, the subject matter of any one of Examples 27-28 can optionally include that the convolutional neural network configurator is to configure the structure of the second convolutional neural network by at least one of configuring a number of neurons or configuring how the neurons are connected in the second convolutional neural network.

In Example 30, the subject matter of any one of Examples 27-29 can optionally include that the tester is to determine whether the at least one of: (a) the sets of the updated weight values, or (b) the combination of the updated weight values satisfies a feature-recognition accuracy threshold by at least one of: (a) accurately identifying features present in input data, or (b) not identifying features that are not present in the input data.

In Example 31, the subject matter of any one of Examples 27-30 can optionally include that the first client devices are mobile cameras.

In Example 32, the subject matter of any one of Examples 27-31 can optionally include that the sensor data generated at the first client devices is at least one of visual capture data, audio data, or motion data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to provide weights for use with convolutional neural networks, the apparatus comprising:
a communication interface to:
send first weight values to first client devices via a network; and
access sets of updated weight values provided by the first client devices via the network, the updated weight values generated by the first client devices training respective first convolutional neural networks based on: (a) the first weight values, and (b) sensor data generated at the first client devices;
a tester to test performance in a second convolutional neural network of at least one of: (a) the sets of the updated weight values, or (b) a combination of ones of the updated weight values from the sets of the updated weight values;
a distribution selector to, based on the testing, select server-synchronized weight values from the at least one of: (a) the sets of the updated weight values, or (b) the combination of the ones of the updated weight values from the sets of the updated weight values; and
the communication interface to send the server-synchronized weight values to at least one of: (a) at least some of the first client devices, or (b) second client devices.

2. The apparatus as defined in claim 1, further including a convolutional neural network configurator to configure a structure of the second convolutional neural network, and the communication interface is to send at least a portion of the second convolutional neural network to the at least one of: (a) the at least some of the first client devices, or (b) the second client devices.

3. The apparatus as defined in claim 1, wherein the convolutional neural network configurator is to configure the structure of the second convolutional neural network by at least one of configuring a number of neurons or configuring how the neurons are connected in the second convolutional neural network.

4. The apparatus as defined in claim 1, wherein the tester is to determine whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

5. The apparatus as defined in claim 1, wherein the first client devices are mobile cameras.

6. The apparatus as defined in claim 1, wherein the sensor data generated at the first client devices is at least one of visual capture data, audio data, or motion data.

7. The apparatus as defined in claim 1, wherein the communication interface, the tester, and the distribution selector are implemented at a server.

8. An apparatus to provide weights for use with convolutional neural networks, the apparatus comprising:
means for testing performance of at least one of: (a) sets of updated weight values, or (b) a combination of the updated weight values in a first convolutional neural network, the updated weight values obtained from first client devices via a network, the updated weight values generated by the first client devices training respective second convolutional neural networks based on: (a) first weight values, and (b) sensor data generated at the first client devices; and
means for selecting server-synchronized weight values from the at least one of: (a) the sets of the updated weight values, or (b) the combination of the updated weight values.

9. The apparatus as defined in claim 8, further including means for configuring a structure of the second convolutional neural network, and means for communicating to send at least a portion of the second convolutional neural network to the at least one of: (a) the at least some of the first client devices, or (b) the second client devices.

10. The apparatus as defined in claim 9, wherein the means for configuring the structure is to configure the structure of the second convolutional neural network by at least one of configuring a number of neurons or configuring how the neurons are connected in the second convolutional neural network.

11. The apparatus as defined in claim 8, wherein the means for testing is to determine whether the at least one of: (a) the sets of the updated weight values, or (b) the combination of the updated weight values satisfies a feature-recognition accuracy threshold by at least one of: (a) accurately identifying features present in input data, or (b) not identifying features that are not present in the input data.

12. The apparatus as defined in claim 8, wherein the first client devices are mobile cameras.

13. The apparatus as defined in claim 8, wherein the sensor data generated at the first client devices is at least one of visual capture data, audio data, or motion data.

14. The apparatus as defined in claim 8, further including means for communicating the first weight values to the first client devices via the network.

15. A non-transitory computer readable storage medium comprising instructions that, when executed, cause at least one processor to at least:
send first weight values to first client devices via a network;
access sets of updated weight values provided by the first client devices via the network, the updated weight values generated by the first client devices training respective first convolutional neural networks based on: (a) the first weight values, and (b) sensor data generated at the first client devices;
test performance in a second convolutional neural network of at least one of: (a) the sets of the updated weight values, or (b) a combination of ones of the updated weight values from the sets of the updated weight values;
based on the testing, select server-synchronized weight values from the at least one of: (a) the sets of the updated weight values, or (b) the combination of the ones of the updated weight values from the sets of the updated weight values; and
send the server-synchronized weight values to at least one of: (a) at least some of the first client devices, or (b) second client devices.

16. The non-transitory computer readable storage medium as defined in claim 15, wherein the instructions further cause the at least one processor to:
configure a structure of the second convolutional neural network, and
send at least a portion of the second convolutional neural network to the at least one of: (a) the at least some of the first client devices, or (b) the second client devices.

17. The non-transitory computer readable storage medium as defined in claim 16, wherein the instructions further cause the at least one processor to configure the structure of the second convolutional neural network by at least one of configuring a number of neurons or configuring how the neurons are connected in the second convolutional neural network.

18. The non-transitory computer readable storage medium as defined in claim 15, wherein the instructions further cause the at least one processor to determine whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

19. The non-transitory computer readable storage medium as defined in claim 15, wherein the first client devices are mobile cameras.

20. The non-transitory computer readable storage medium as defined in claim 15, wherein the sensor data generated at the first client devices is at least one of visual capture data, audio data, or motion data.

21. A method to provide weights for use with convolutional neural networks, the method comprising:
sending, by a server, first weight values to first client devices via a network;
accessing, at the server, sets of updated weight values provided by the first client devices via the network, the updated weight values generated by the first client devices training respective first convolutional neural networks based on: (a) the first weight values, and (b) sensor data generated at the first client devices;
testing, by executing an instruction with the server, performance in a second convolutional neural network of at least one of: (a) the sets of the updated weight values, or (b) a combination of ones of the updated weight values from the sets of the updated weight values;
selecting based on the testing, by executing an instruction with the server, server-synchronized synchronized weight values from the at least one of: (a) the sets of the updated weight values, or (b) a combination of ones of the updated weight values from the sets of the updated weight values; and
sending, by the server, the server-synchronized weight values to at least one of: (a) at least some of the first client devices, or (b) second client devices.

22. The method as defined in claim 21, further including configuring a structure of the second convolutional neural network, and sending at least a portion of the second convolutional neural network to the at least one of: (a) the at least some of the first client devices, or (b) the second client devices.

23. The method as defined in claim 22, wherein the structure of the second convolutional neural network is configured by at least one of configuring a number of neurons or configuring how the neurons are connected in the second convolutional neural network.

24. The method as defined in claim 21, wherein the testing of the performance is to determine whether the at least one of: (a) the sets of the updated weight values, or (b) the combination of the ones of the updated weight values from the sets of the updated weight values satisfies a feature-recognition accuracy threshold by at least one of: (a) accurately identifying features present in input data, or (b) not identifying features that are not present in the input data.

25. The method as defined in claim 21, wherein the first client devices are mobile cameras.

26.-32. (canceled)
